(19) United States
(12) Patent Application Publication
(10) Pub. No.: US 2009/0202955 A1
(43) Pub. Date: Aug. 13, 2009

(54) GASIFICATION FEED INJECTORS AND METHODS OF MODIFYING THE CAST SURFACES THEREOF

(75) Inventor: Hoyle Jang, Greenville, SC (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/027,373

(22) Filed: Feb. 7, 2008

(51) Int. Cl. F23D 11/38; B05B 1/00; C21D 7/06

(52) U.S. Cl. 431/159; 239/589; 72/53

(57) ABSTRACT

Gasification feed injectors for injecting fluids into a combustion chamber and methods of modifying the cast surfaces of such injectors are provided. In an embodiment, a feed injector for injecting a fluid into a combustion chamber comprises a nozzle defining an interior flow passage, the nozzle comprising a cast surface modified to have an ASTM grain size number of about 2 to about 9.

### BACKGROUND OF THE INVENTION

This disclosure relates generally to feed injectors and, more specifically, to coal gasification feed injectors and methods of modifying the cast surfaces thereof to improve their fatigue resistance.

Synthesis gas (syngas) mixtures comprising carbon monoxide and hydrogen are important commercially as a source of hydrogen for hydrogenation reactions and as a source of feed gas for the synthesis of hydrocarbons, oxygen-comprising organic compounds, and ammonia. One method of producing syngas is by the gasification of coal, which involves the partial combustion of this sulfur-comprising hydrocarbon fuel with oxygen-enriched air. One type of gasification process known as the slagging-type process can involve feeding a coal-water slurry and oxygen to the combustion chamber through a water-cooled feed injector that is inserted in the top of the refractory-lined chamber. A hot gas flue stream is produced in the combustion chamber that can include hydrogen, carbon monoxide, and carbon dioxide, and can additionally include methane, hydrogen sulfide, and nitrogen, depending on fuel source and reaction conditions.

Various precautions can be taken to ensure that the gasification process produces the desired amount of syngas. For example, very rapid and complete mixing of the reactants can be performed, and special precautions can be taken to protect the burner or mixer from overheating. Because of the tendency for the oxygen and sulfur contaminants in coal to react with the metal from which the burner is fabricated, the burner elements can be operated at temperatures below which rapid oxidation and corrosion takes place. Special precautions can also be taken to ensure that the reaction between the hydrocarbon and the oxygen takes place entirely outside the burner proper and to prevent the localized concentration of combustible mixtures at or near the surfaces of the burner elements.

Various elements of the gasification system such as the tip of the feed injector are undesirably subjected to radiative heating from the combustion zone. For these and other reasons, the tip of the feed injector can experience failure due to metal corrosion even though the tip is water-cooled. After only a short period of operation, fatigue cracks can develop in the cast surface of the tip of the feed injector. Eventually these cracks can penetrate through the wall of the feed injector, allowing process fluids to leak. Due to this leakage, the operation of the gasification system needs to be ceased to replace the feed injector, resulting in a costly loss in production time.

### SUMMARY OF THE INVENTION

Disclosed herein are feed injectors for injecting fluids into a combustion chamber and methods of modifying the cast surfaces of such injectors. In an embodiment, a feed injector for injecting a fluid into a combustion chamber comprises a nozzle defining an interior flow passage, the nozzle comprising a cast surface modified to have an ASTM grain size number of about 2 to about 9.

In another embodiment, a method of modifying a cast surface of a feed injector comprises: shot peening the cast surface of the feed injector; and heating the cast surface at a temperature effective to cause the surface to have an ASTM grain size number of about 2 to about 9.

### BRIEF DESCRIPTION OF THE DRAWINGS

Referring now to the FIGURE, which is an exemplary embodiment, and wherein the like elements are numbered alike: the FIGURE is a schematic side view of an embodiment of a feed injector for injecting fluids into a combustion chamber.

### DETAILED DESCRIPTION OF THE INVENTION

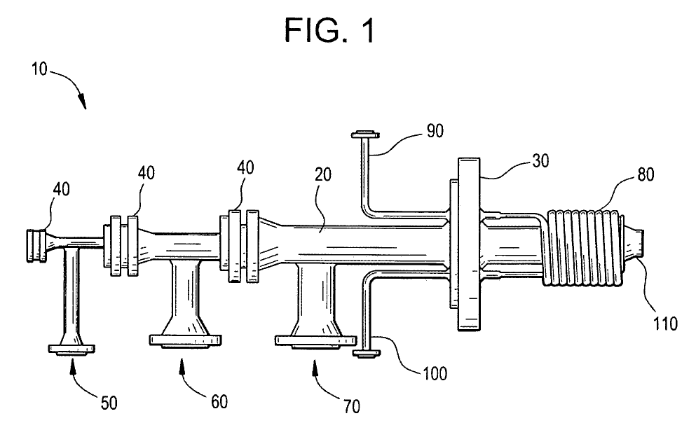

The FIGURE depicts an exemplary embodiment of a feed injector 10 that can be used to inject fluids into a reaction chamber (not shown). As shown, the feed injector 10 can include a nozzle 20 defining an interior flow passage (not shown) and a main flange 30 and three secondary flanges 40 for securing the nozzle 20. Inlets 50, 60, and 70 can be configured to supply a secondary oxygen-comprising stream, a feed stream, and a primary oxygen-comprising stream, respectively, to different sections of the nozzle 20. The end of the nozzle 20 leading into the reaction chamber can be at least partially surrounded by a cooling coil 80 through which a cooling fluid such as water flows. The cooling fluid inlet 90 and outlet 100 are also shown in FIG. 1. One exemplary application of the feed injector 10 can be in a coal gasification system. In this case, the feed stream can include a slurry comprising coal and water. In alternative embodiments, the coal can be replaced with or supplemented by other fuels such as petroleum coke, a coal/petroleum coke blend, a biomass/coal/petroleum coke blend, etc.

The nozzle 20 can be formed by casting molten metal or metal alloys, such as cobalt-based alloys, nickel-based superalloys, iron-based alloys, and stainless steels, into the desired shape of the nozzle. The fatigue strength of the nozzle 20 formed in this manner can be compromised by coarse grain sizes that are present near the cast surface. Fortunately, the cast surface can be made more resistant to fatigue cracking by thermomechanically modifying the surface of the nozzle 20, particularly near the tip 110 of the nozzle 20, to induce the formation of finer grains near the surface Modifying the surface of the nozzle 20 in this manner can advantageously extend its service life without making any major design changes in the nozzle and without significantly increasing the cost of manufacturing the nozzle. The modified cast surface desirably has an ASTM (American Society for Testing and Materials) grain size number of about 2 to about 9, based on ASTM Specification No. E112 found in the 2004 Annual Book of ASTM Standards, Volume No. 03.01. More specifically, the ASTM grain size number can be about 3 to about 5, or alternatively, about 6 to about 8. The ASTM grain size number corresponds to the average diameter of the grains in a representative section of the modified cast surface. Table 1 below provides the grain diameters corresponding to various ASTM grain sizes.

TABLE 1

| ASTM Grain | Average Grain Diameter | Average Grain Diameter |
|---|---|---|
| Size Number | (mm) | (in) |
| 0000 | 1.02 | 0.04 |
| 000 | 0.71 | 0.028 |
| 00 | 0.51 | 0.02 |
| 0 | 0.36 | 0.014 |
| .5 | 0.3 | 0.012 |
| 1.0 | 0.25 | 0.0098 |
| 1.5 | 0.21 | 0.0083 |
| 2.0 | 0.18 | 0.0071 |
| 2.5 | 0.15 | 0.0059 |
| 3.0 | 0.125 | 0.0049 |
| 3.5 | 0.105 | 0.0041 |
| 4.0 | 0.09 | 0.0035 |
| 4.5 | 0.075 | 0.003 |
| 5.0 | 0.065 | 0.0026 |
| 5.5 | 0.055 | 0.0022 |
| 6.0 | 0.045 | 0.0018 |
| 6.5 | 0.038 | 0.0015 |
| 7.0 | 0.032 | 0.0013 |
| 7.5 | 0.027 | 0.0011 |
| 8.0 | 0.022 | 0.00087 |
| 8.5 | 0.019 | 0.00075 |
| 9.0 | 0.016 | 0.00063 |
| 9.5 | 0.013 | 0.00051 |
| 10.0 | 0.011 | 0.00043 |

In an exemplary embodiment, the cast surface of the nozzle can be modified by shot peening the surface to form dimples therein, followed by thermally treating the surface to cause the grains present at the surface to become less coarse. In various embodiments, this thermal treatment involves heating the surface at a temperature of about 1,750° F. to about 2,150° F., more specifically at a temperature of about 1,775° F. to about 2,125° F., and even more specifically at a temperature of about 1,790° F. to about 2,110° F. In various embodiments, the heating can be performed for a period of about 20 minutes to about 100 minutes, more specifically for a period of about 30 minutes to about 90 minutes, and even more specifically for a period of about 55 minutes to about 65 minutes.

Shot peening is a process used to modify the mechanical properties of a material by impacting the surface of the material with round particles (i.e., shot) using a force sufficient to create plastic deformation in the material. It is similar to sandblasting, except that it operates by the mechanism of plasticity rather than abrasion. In practice, this means that less material is removed and less dust is created by the process. Shot peening a surface effectively spreads that surface plastically in the manner of a rivet, causing changes in the mechanical properties of the surface. More details related to the shot peening process can be found in the SAE Manual on Shot Peening, Society of Automotive Engineers, August 2001.

The particular type of shot used, the shot intensity, and the shot coverage can be varied to achieve the desired grain size. Examples of suitable types of shot include but are not limited to cast metal shot such as steel shot and stainless steel shot, ceramic shot, glass shot, cut wire shot such as CW31 (has a nominal diameter of 0.031 inch), and combinations comprising at least one of the foregoing. Examples of cast shots include S110, S660 S550 S460 S390 S330 S280 S230 S170 and S70 shots, which have varying diameters (e.g., S110 shot has a nominal diameter of 0.0110 inch). The shot intensity can be about 8 A to about 20 A, more specifically about 8 A to about 10 A. The shot coverage can be about 100% to about 200%, more specifically about 100%, of the cast surface.

The shot intensity can be determined using a standard procedure described in the Society of Automotive Engineers (SAE) Standard J443. Society of Automotive Engineers, January 2003. This procedure entails placing several (e.g., at least 4) Almen strips in a shot chamber, exposing the Almen strips to the shot blast stream for increasingly longer times, and plotting the arc-height versus exposure time. The peening “intensity” is the value of the arc-height curve at time T1 that is within 10% of the arc-height curve value at twice the time or T2. The intensity can be controlled by based on the arc-height. For example, an intensity of 8 A to 10 A is achieved when the arc-height is within the 0.008 to 0.010 inch range with the A strip.

An Almen strip is a thin strip of steel used in the control of a shot peening process. It was developed and patented by John Almen. The strip was originally supported by 2 knife edges, but his design was superceeded by the #2 Almen gage developed by General Motors in 1943. The original design was altered in two ways: the knife edges used to support the strip were replaced with four small balls; and the strip was inverted so that the indicator tip would always touch the non-peened side of the strip. The four-ball support recognized the compound curve nature of the strip. Having the indicator tip touch the non-peened surface precluded erroneous reading from nesting the dial indicator tip in the bottom or top of a peening dimple. It also extended the lifetime of the tip since operators tended to slide the strip back and forth searching for a desired reading. Modern Almen gages have end stops to ensure that the reading is taken from the central portion of the strip.

The amount of shot coverage can be controlled to achieve complete coverage by submitting the cast surface of the nozzle to the shot blast stream for a brief period of time and then examining the surface to estimate the percentage of surface dimpling. The part can then be exposed to further treatment. This process can be repeated until the surface exhibits a complete obliteration of the original surface with overlapping dimples.

In accordance with an embodiment, the modified feed injector described herein can be employed to inject the reactant-comprising components (i.e. oxygen-enriched air and a coal slurry) under significant pressure, such as about 80 bar, into a coal gasification combustion chamber. The feed injector serves to mix and atomize the reactants and to control the fluid flow pattern so as to maximize carbon conversion efficiency. A hot flue gas including hydrogen, carbon monoxide, and carbon dioxide can be produced in the combustion chamber. It can also include methane, hydrogen sulfide, and nitrogen, depending on the fuel source and reaction conditions. By way of example, the temperature and pressure of the gas in the chamber can be about 700° F. to about 2,500° and about 1 atmosphere (atm) to about 300 atm, more specifically about 10 atm to about 100 atm, respectively.

As used herein, the terms “a” and “an” do not denote a limitation of quantity, but rather denote the presence of at least one of the referenced items. Moreover, the endpoints of all ranges directed to the same component or property are inclusive of the endpoint and independently combinable (e.g., “about 5 wt % to about 20 wt %.” is inclusive of the endpoints and all intermediate values of the ranges of “about 5 wt. % to about 20 wt %,”). Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. It is also to be understood that the disclosure is not limited by any theories described therein. Unless defined otherwise, technical and scientific terms used herein have the same meaning as is commonly understood by one of skill in the art to which this invention belongs.

While the invention has been described with reference to exemplary embodiments, it will be understood that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A feed injector for injecting a fluid into a combustion chamber, comprising: a nozzle defining an interior flow passage, the nozzle comprising a cast surface modified to have an ASTM grain size number of about 2 to about 9.

2. The feed injector of claim 1, wherein the ASTM grain size number is about 3 to about 8.

3. The feed injector of claim 2, wherein the ASTM grain size number is about 6 to about 8.

4. The feed injector of claim 2, wherein the ASTM grain size number is about 5 to about 6.

5. The feed injector of claim 1, wherein the cast surface comprises dimples formed by shot peening the surface at a shot intensity of about 8 A to about 20 A.

6. The feed injector of claim 5, wherein the dimples have a shot coverage of about 100% to about 200% of the cast surface.

7. The feed injector of claim 1, wherein the modified cast surface is located near a tip of the nozzle.

8. The feed injector of claim 1, wherein the modified cast surface comprises a metal or a metal alloy.

9. A gasification system comprising the feed injector of claim 1 and a combustion chamber, the feed injector being configured to deliver a fuel and a gas comprising oxygen to the combustion chamber.

10. A method of modifying a cast surface of a feed injector, comprising:
peening the cast surface of the feed injector; and
heating the cast surface at a temperature effective to cause the surface to have an ASTM grain size number of about 2 to about 9.

11. The method of claim 10, wherein the ASTM grain size number is about 3 to about 8.

12. The method of claim 11, wherein the ASTM grain size number is about 6 to about 8.

13. The method of claim 11, wherein the ASTM grain size number is about 5 to about 6.

14. The method of claim 10, wherein the cast surface comprises a metal or a metal alloy.

15. The method of claim 10, wherein said peening comprises shot peening at a shot intensity of about 8 A to about 20 A.

16. The method of claim 10, wherein said peening comprises shot peening using a shot coverage of about 100% to about 200% of the cast surface.

17. The method of claim 10, wherein said peening comprises shot peening using cast metal shot, cast steel shot, cast stainless steel shot, ceramic shot, glass shot, cut wire shot, or a combination comprising at least one of the foregoing.

18. The method of claim 10, wherein the temperature is about 1,750° F. to about 2,150° F.

19. The method of claim 18 wherein the cast surface is heated at the temperature for a period of about 20 minutes to about 100 minutes.

20. The method of claim 10, wherein the modified cast surface is located near a tip of the feed injector.
